(19) United States
(12) Patent Application Publication
(10) Pub. No.: US 2009/0130556 A1
(43) Pub. Date: May 21, 2009

(54) NONAQUEOUS ELECTROLYTE SECONDARY BATTERY AND NONAQUEOUS ELECTROLYTE COMPOSITION

(75) Inventor: Atsumichi Kawashima, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/269,534

(22) Filed: Nov. 12, 2008

(30) Foreign Application Priority Data
Nov. 16, 2007 (JP) 2007-297608

(51) Int. Cl. H01M 10/00

(52) U.S. Cl. 429/200

(57) ABSTRACT

A nonaqueous electrolyte composition is disclosed. The composition includes a compound with oxygen and halogen coordinated on an element selected from Groups 4 to 15 in the periodic table.

### CROSS REFERENCES TO RELATED APPLICATIONS

The present application claims priority to Japanese Patent Application JP 2007-297608 filed in the Japanese Patent Office on Nov. 16, 2007, the entire contents of which is incorporated herein by reference.

### BACKGROUND

The present application relates to a nonaqueous electrolyte secondary battery capable of suppressing expansion under a high temperature environment while appropriately maintaining cycle characteristics.

Recently, various mobile electronic apparatuses such as camcorders, digital still cameras, mobile telephones, personal digital assistants, and notebook type computers have been on the market and the sizes and the weights thereof have been reduced. As a mobile power source of such electronic apparatuses, with respect to a battery and more particularly a secondary battery, researches into the improvement of energy density are actively ongoing. Among them, a lithium ion secondary battery which uses carbon in a negative electrode active material, lithium/transition metal compound oxide as a positive electrode active material, and a carbonic ester mixture as an electrolytic solution comes into wide use because larger energy density can be obtained compared with a lead battery or a nickel-cadmium battery which are the existing nonaqueous electrolyte secondary batteries. Since a laminate battery having an aluminum laminated film formed on the outside thereof is a thin package and a light weight, the amount of active material can be increased and thus the energy density is large.

In these lithium ion secondary batteries, in order to improve the battery characteristics such as cycle characteristics, for example, a method of adding various additive agents to a nonaqueous electrolytic solution (hereinafter, referred to as an electrolytic solution) is suggested (see JP-A-2005-38722 and JP-A-2006-107796).

### SUMMARY

However, in the electronic apparatuses using the secondary battery, power consumption has been increased and thus the amount of heat generated has been increased. Thus, the operation environment of the battery is changed to a high temperature. If the battery is exposed to the high temperature environment, carbonic ester in the electrolytic solution may be decomposed by the reaction with an electrode and thus gas may be generated. This phenomenon is particularly problematic in a thin battery such as a laminate battery, because the battery expands.

The present inventor found that, the expansion of the battery under the high temperature environment can be suppressed by the addition of chloride of Groups 4 to 15 in the periodic table. However, there is a problem that the chloride is likely to be hydrolyzed or is unlikely to be dissolved in the electrolytic solution.

Thus, it is desired to provide an electrolyte capable of suppressing the expansion of a battery under a high temperature environment while maintaining charging/discharging efficiency and a battery using the same.

According to the present application, it was found that it is possible to provide a battery capable of suppressing the expansion of the battery at a high temperature while maintaining good charging/discharging efficiency, by including a compound with oxygen and halogen coordinated on a specific element in an electrolytic solution.

According to an embodiment, there are provided a nonaqueous electrolyte secondary battery and a nonaqueous electrolyte composition described below.

(1) A nonaqueous secondary battery having a positive electrode, a negative electrode and a nonaqueous electrolytic solution, wherein the nonaqueous electrolytic solution includes a compound with oxygen and halogen coordinated on an element selected from Groups 4 to 15 in the periodic table.

(2) A nonaqueous electrolyte composition including a compound with oxygen and halogen coordinated on an element selected from Groups 4 to 15 in the periodic table.

According to the nonaqueous electrolyte composition and the nonaqueous secondary battery according to an embodiment, the compound with oxygen and halogen coordinated on the specific element in the electrolytic solution is decompressed on the surface of an electrode at the time of first charging to form a protective film of lithium halide such that it is possible to suppress the generation of gas due to the reaction between the electrolytic solution and the active material of the battery.

Accordingly, it is possible to provide a battery capable of suppressing the expansion of the battery at a high temperature while maintaining charging/discharging efficiency.

Additional features and advantages are described herein, and will be apparent from the following Detailed Description and the figures.

### BRIEF DESCRIPTION OF THE FIGURES

FIG. 1 is an exploded perspective view showing the configuration of a nonaqueous electrolyte secondary battery according to an embodiment.

FIG. 2 is a cross-sectional view showing the configuration taken along line I-I of a wound electrode body shown in FIG. 1.

### DETAILED DESCRIPTION

An embodiments will be described with reference to the accompanying drawings, where the present application is not limited to the following embodiment.

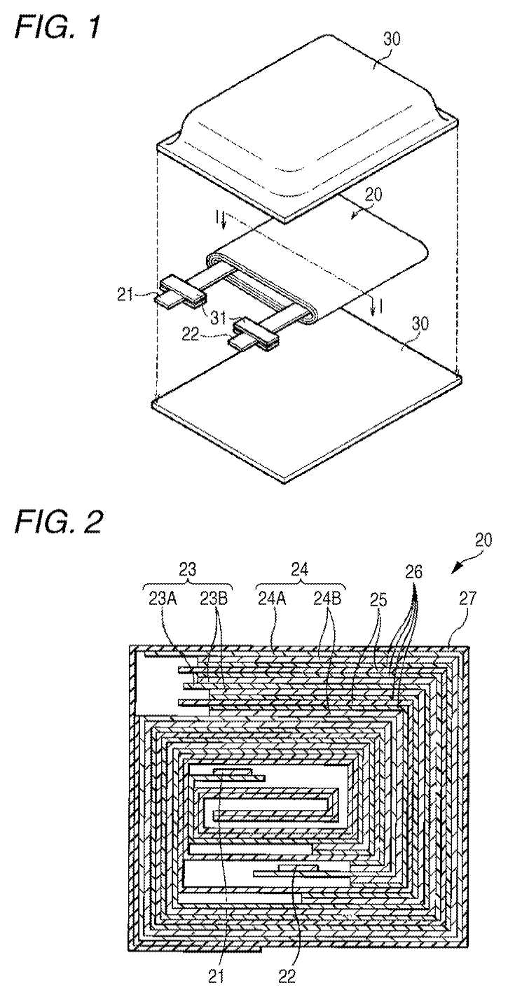

FIG. 1 is a view schematically showing the configuration of a laminate battery according to an embodiment. This secondary battery is a laminate film type battery in which a wound electrode body 20 to which a positive electrode lead 21 and a negative electrode lead 22 are attached is contained in an exterior member 30 having a film shape.

The positive electrode lead 21 and the negative electrode lead 22 protrude from the inside of the exterior member 30 to the outside thereof in the same direction. The positive electrode lead 21 and the negative electrode lead 22 are formed of a metal material such as aluminum, copper, nickel or stainless steel and have a thin shape or a mesh shape.

The exterior member 30 is constituted by a rectangular aluminum laminated film in which a nylon film, an aluminum film and a polyethylene film are attached in this order. The exterior member 30 is arranged such that the polyethylene film and the wound electrode body 20 face each other and the outer portions thereof are adhered by fusion or an adhesive. An adhesion film 31 for preventing permeation of ambient air is inserted between the exterior member 30 and the positive electrode lead 21 and between the exterior member 30 and the negative electrode lead 22. The adhesion film 31 is formed of a material having an adhesive property with respect to the positive electrode lead 21 and the negative electrode lead 22, for example, polyolefin resin such as polyethylene, polypropylene or modified polyethylene or modified polypropylene.

The exterior member 30 may be formed of a laminate film having the other structure than mentioned above, or a high molecular material film such as polypropylene or a metal film, instead of the aluminum laminated film.

FIG. 2 is a view showing the cross-sectional structure taken along line I-I of the wound electrode body 20 shown in FIG. 1. The wound electrode body 20 is formed by laminating and winding a positive electrode 23 and a negative electrode 24 with a separator 25 and an electrolytic layer 26 interposed therebetween and the outermost circumference portion thereof is protected by a protective tape 27.

### (Active Material Layer)

The positive electrode 23 has a structure in which positive electrode active material layers 23B are provided on the both surfaces of a positive electrode current collector 23A. The negative electrode 24 has a structure in which negative electrode active material layers 24B are provided on the both surfaces of a negative electrode current collector 24A, and the negative electrode active material layer 24B and the positive electrode active material layer 23B face each other. In the nonaqueous secondary battery of an embodiment, it is preferable that the positive electrode active material layer 23B is coated and dried so as to become 14 to 30 mg/cm² based on one side and the negative electrode active material layer 24B is coated and dried so as to become 7 to 15 mg/cm² based on one side. The thicknesses of one side of the positive electrode active material layer 23B and the negative electrode active material layer 24B are from 40 μm to 80 μm and more preferably 40 μm to 60 μm. If the thickness of the active material layer is 40 μm or more, the high capacity of the battery can be realized. If the thickness of the active material layer is 80 μm or less, a discharging capacity maintenance rate when charging/discharging is repeated is increased.

### (Positive Electrode)

The positive electrode current collector 23A is formed of a metal material such as aluminum, nickel and stainless steel. The positive electrode active material layer 24B includes any one or a plurality of positive electrode materials for storing and releasing lithium as a positive electrode active material and, if necessary, may include a conductive agent such as a carbon material and a binder such as polyvinylidene fluoride.

As the positive electrode material which can store and release lithium, for example, lithium cobaltate, lithium nickelic oxide or the solid solution thereof (Li(NiCo_{y}Mn_{z})O₂))(values x, y and z are 0<x<1, 0<y<1, 0≦z<1, x+y+z=1), a lithium composite oxide such as manganese spinel (LiMn₂O₄) and the solid solution thereof (Li(Mn₂₋ᵥNiᵥ)O₄) (a value v is v<2), a phosphate compound having an olivine structure, such as lithium iron phosphate (LiFePO₄) are preferably used, because high energy density can be obtained. As the positive electrode material which can store and release lithium, for example, oxide such as titanium oxide, vanadium oxide or manganese dioxide, disulfide such as iron sulfide, titanium disulfide or molybdenum sulfide, sulfur, a conductive polymer such as polyaniline or polythiophene may be used.

### (Negative Electrode)

The negative electrode 24 has a structure in which the negative electrode active material layers 24B are provided on the both surfaces of the negative electrode current collector 24A having a pair of opposite surfaces. The negative electrode current collector 24A is formed of, for example, a metal material such as copper, nickel and stainless steel.

The negative electrode active material layer 24B includes any one or a plurality of negative electrode materials which can store and release lithium as the negative electrode active material. In the secondary battery, the charging capacity of the negative electrode material which can store and release lithium is larger than that of the positive electrode 23 and thus lithium metal is not deposited on the negative electrode 24 during charging.

As the negative electrode material which can store and release lithium, for example, a carbon material such as hardly graphitizable carbon, easily graphitizable carbon, graphite, thermally decomposed carbon, coke, glassy carbon, organic high molecular material compound fired substance, carbon fiber, or activated carbon may be used. Among them, coke may include pitch coke, needle coke and petroleum coke. The organic high molecular material compound fired substance indicates a substance obtained by firing a high molecular material such as phenol resin or furane resin at a proper temperature and carbonating the material and may be classified into hardly graphitizable carbon or easily graphitizable carbon.

The high molecular material includes, for example, polyacetylene and polypyrrole. These carbon materials are preferable because a variation in crystal structure generated at the time of charging/discharging is small, a high charging/discharging capacity can be obtained, and good cycle characteristics can be obtained. In particular, graphite is preferable because an electrochemical equivalent is large and high energy density can be obtained. Hardly graphitizable carbon is preferable because excellent characteristics can be obtained. A material having a low charging/discharging potential, that is, a material of which a charging/discharging potential is close to that of lithium metal, can readily realize the high energy density of the battery.

As the negative electrode material, silicon, tin and a compound thereof, a material including an element for manufacturing an alloy with lithium, such as magnesium, aluminum or germanium, may be used instead of the carbon material. In addition, a material including an element for forming composite oxide and lithium as titanium may be used.

### (Separator)

The separator 25 separates the positive electrode 23 and the negative electrode 24 and passes a lithium ion while preventing the short circuit of a current due to the contact between the both electrodes. The separator 25 is formed of a porous film made of ceramic or a porous film made of synthetic resin, which is formed of polytetrafluoroethylene, polypropylene and polyethylene, and may have a lamination including a plurality of porous films. In the separator 25, for example, an electrolytic solution which is a liquid electrolyte is immersed.

### (Nonaqueous Electrolytic Solution)

The nonaqueous electrolytic solution of an embodiment includes a compound with oxygen and halogen coordinated on an element selected from Groups 4 to 15 in the periodic table. The compound is decomposed on the surface of an electrode at the time of first charging to form a protective film of lithium halide such that it is possible to suppress the generation of gas due to the reaction between the electrolytic solution and the active material of the battery. When this compound is dissolved in the electrolytic solution, halide ions are not generated in the electrolytic solution. If the halide ions exist, the halide ions are combined with the lithium ions to form an insoluble lithium halide and thus the electrolytic solution becomes clouded. However, this compound does not cause this phenomenon even when being dissolved in the electrolytic solution.

As the element selected from Groups 4 to 15 in the periodic table, titanium and zirconium of the group 4, vanadium and niobium of the group 5, chrome and molybdenum of the group 6, aluminum of the group 13 and phosphorus of the group 15 are preferably used. Among them, vanadium and molybdenum are particularly preferable in view of the stability of a reagent.

As the compound with oxygen and halogen coordinated on the element selected from Groups 4 to 15 in the periodic table, the compound with chlorine as halogen is preferable. Since the ionicity of fluoride is larger than chlorine, solubility of an organic electrolytic solution is small. Bromide hardly becomes a protective film because the solubility of lithium bromide generated is large.

The concentration of the compound with oxygen and halogen coordinated in the nonaqueous electrolytic solution is preferably 0.02 to 0.5 mass % and more preferably 0.05 to 0.2 mass %. If the concentration is in the range from 0.02 to 0.5 mass %, a sufficient film is formed and resistance is small.

In the coordination of oxygen, oxygen of ether having the structure shown by Formula (1) or (2) may be coordinated in addition to oxygen. This is because ether is insufficient in reactivity.

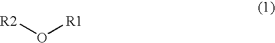

In Formula (1), R1 and R2 each independently denotes an alkyl group having a carbon number of 1 to 4 and ether having the structure expressed by Formula (1) includes, for example, diethyl ether, diisopropyl ether, and methyl-t-butyl ether.

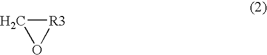

In Formula (2), R3 denotes an alkylene group having a carbon number of 1 to 5 and ether having the structure expressed by Formula (2) includes, for example, oxetane, tetrahydrofuran and tetrahydropyran.

The compound with chlorine and oxygen coordinated may be the compound in which an oxide ion is coordinated such as vanadyl chloride (VOCl₃), chromyl chloride (CrO₂Cl₂), molybdenum dichloride dioxide (MoO₂Cl₂) and phosphoryl chloride (POCl₃). The compound with chlorine and oxygen coordinated may be the compound in which ether is coordinated such as titanium tetrachloride/2THF, zirconium tetrachloride/2THF, vanadium trichloride/3THF, niobium tetrachloride/2THF, chrome trichloride/3THF and aluminum trichloride/THF in which ether is tetrahydrofuran (THF) expressed by Formula (3). However, the present application is not limited to the compound so long as the compound with chlorine and oxygen coordinated on the element selected from Groups 4 to 15 in the periodic table is included.

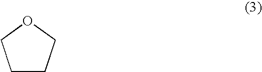

It is preferable that the electrolytic solution of the present application further includes halogenated carbonic ester or carbonate ester having a carbon-carbon multiple bond. This is because carbonate ester suppresses the generation of gas by forming the protective film by another mechanism.

Halogenated carbonic ester includes, for example, fluorinated ethylene carbonate such as 4-fluoro-1,3-dioxolan-2-on(fluoroethylene carbonate) expressed by Formula (4), difluorinated ethylene carbonate such as 4-methyl-5-fluoro-1,3-dioxolan-2-on and 4,5-difluoro-1,3-dioxolan-2-on, ethylene carbonate chloride such as 4-chloro-1,3-dioxolan-2-on(chloroethylene carbonate) expressed by Formula (5), trifluoropropylene carbonate expressed by Formula (6), 4-trifluoromethyl-1,3-dioxolan-2-on and trifluoro ethylene carbonate such as trifluoromethylene ethylene carbonate. The content of halogenated carbonic ester in the electrolytic solution is preferably in a range from 0.1 mass % to 2 mass %. Halogenated carbonic ester may use one kind of them solely or a combination of two or more kinds of them.

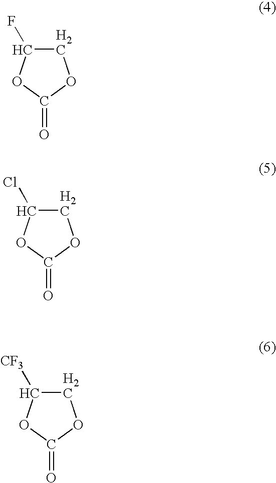

Carbonate ester having the carbon-carbon multiple bond includes, for example, cyclic carbonate ester such as vinylene carbonate, ethylene carbonate, propylene carbonate, butylenes carbonate and vinylethylene carbonate or halogenated carbonic ester obtained by replacing a portion of them with halogen. The content of carbonate ester is preferably 0.1 to 2 mass %. In this range, a sufficient film is formed and the resistance is reduced.

The nonaqueous electrolytic solution of an embodiment further includes a solvent and electrolyte salt dissolved in the solvent. The solvent used in the electrolyte salt is preferably a high-dielectric solvent having specific permittivity of 30 or more. This is because the number of lithium ions can be increased. The content of the high-dielectric solvent in the electrolyte is preferably in a range of 15 to 50 mass %. In this range, higher charging/discharging efficiency can be obtained.

The high-dielectric solvent includes, for example, cyclic carbonate ester such as vinylene carbonate, ethylene carbonate, propylene carbonate, butylenes carbonate and vinylethylene carbonate or lactone such as γ-butyrolactone or γ-valerolactone, lactam such as N-methyl-2-pyrolidone, cyclic carbamate ester such as N-methyl-2-oxazolidinone, and sulfone compound such as tetramethylene sulfone. In particular, cyclic carbonate ester is preferable, and ethylene carbonate and vinylene carbonate having a carbon-carbon double bond are more preferable. The high-dielectric solvent may use one kind of them solely or a combination of two or more kinds of them.

As the solvent used in the electrolytic solution, a low-viscosity solvent having viscosity of 1 mPa·s or less mixed in the high-dielectric solvent is preferably used. This is because high ion conductivity can be obtained. A ratio of the low-viscosity solvent to the high-dielectric solvent is preferably in a range of 2:8 to 5:5. In this range, high effect can be obtained.

The low-viscosity solvent includes, for example, chain carbonate such as dimethyl carbonate, diethyl carbonate, ethylmethyl carbonate and methyl propyl carbonate, chain carboxylate ester such as methyl acetate, ethyl acetate, methyl propionate, ethyl propionate, methyl butyrate, methyl isobutyrate, trimethyl acetate methyl and trimethyl acetate ethyl, chain amide such as N,N-dimethylacetamide, chain carbamate ester such as N,N-diethyl carbamate methyl and N,N-diethyl carbamate ethyl, and ether such as 1,2-dimethoxyethane, tetrahydrofuran, tetrahydropyran and 1,3-dioxolan. The low-viscosity solvent may use one kind of them solely or a combination of two or more kinds of them.

The electrolyte salt includes, for example, inorganic lithium salt such as lithium phosphate hexafluoride (LiPF₆), lithium tetrafluoroborate (LiBF₄), lithium arsenate hexafluoride (LiAsF₆), lithium antimonite hexafluoride (LiSbF₆), lithium perchlorate (LiClO₄) and lithium aluminum acid tetrachloride (LiAlCl₄), a lithium salt of perfluoro alkane sulfonate derivative such as lithium trifluoro methane sulfonate (CF₃SO₃Li), lithium bis(trifluoro methane sulfone) imide [(CF₃SO₂)₂NLi], lithium bis(pentafluoro ethane sulfone) imide [(C₂F₅SO₂)₂NLi] and lithium tris(trifluoro methane sulfone) mechide [(CF₃SO₂)₃CLi]. The electrolyte salt may use one kind of them solely or a combination of two or more kinds of them. The content of the electrolyte salt in the electrolytic solution is preferably 6 to 25 mass %.

### High-Molecular Compound

The battery of an embodiment may be a gel form electrolyte battery including a high molecular compound as a retaining body which swells and retains the electrolyte solution. By including the high molecular compound which swells the electrolyte solution, high ion conductivity can be obtained, excellent charging/discharging efficiency can be obtained, and electrolyte leakage of the battery can be prevented. When the high molecular compound is included in addition to the electrolytic solution, the content of the high molecular compound in the electrolytic solution is preferably in a range from 0.1 mass % to 2 mass %. In case a high molecular compound such as polyvinylidene fluoride is coated on the both surfaces of the separator, the mass ratio of the high molecular compound to the electrolytic solution is preferably in a range 50:1 to 10:1. In this range, higher charging/discharging efficiency can be obtained.

The high molecular compound may be, for example, an ester system high molecular compound such as polyvinyl formal expressed by Formula (7), polyethylene oxide or a crosslinking body including polyethylene oxide, an ester system high molecular compound such as polymethacrylate expressed by Formula (8), an acrylate system high molecular compound, a polymer of vinylidene fluoride such as polyvinylidene fluoride expressed by Formula (9), or a copolymer of vinylidene fluoride and hexafluoropropylene. As the high molecular compound, one kind of them solely or a combination of two or more kinds of them can be included. In particular, from the viewpoint of the prevention of the expansion under high temperature, a fluorine system high molecular compound such as polyvinylidene fluoride is preferably used.

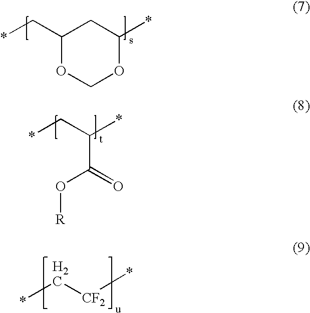

In Formulae (7) to (9), s, t and u denote integers of 100 to 10000 and R denotes CxH₂ₓ₊₁O_{y} (x is an integer of 1 to 8, y is an integer of 0 to 4, and y is x−1 or less).

### (Manufacturing Method)

The secondary battery may be manufactured as follows.

The positive electrode may be manufactured by the following method. First, the positive electrode active material, the conductive agent, and the binder are mixed to manufacture a positive electrode mixture agent and the positive electrode mixture agent is dispersed in a solvent such as N-methyl-2-pyrolidone to manufacture a paste positive electrode mixture slurry. Subsequently, the positive electrode mixture slurry is coated on the positive electrode current collector 23A, the solvent is dried, compression is performed by a roll press machine, the positive electrode active material layer 23B is formed, and the positive electrode 23 is manufactured. At this time, the thickness of the positive electrode active material layer 23B is 40 μm or more.

The negative electrode may be manufactured by the following method. First, the negative electrode active material including at least one of silicon and tin as the component, the conductive agent and the binder are mixed to manufacture a negative electrode mixture agent and the negative electrode mixture agent is dispersed in a solvent such as N-methyl-2-pyrolidone to manufacture a paste negative electrode mixture slurry. Next, the negative electrode mixture slurry is coated on the negative electrode current collector 24A, the solvent is dried, compression is performed, the negative electrode active material layer 24B including the negative electrode active material particles formed of the negative electrode active material is formed, and the negative electrode 24 is manufactured. At this time, the thickness of the negative electrode active material layer 24B is 40 μm or more.

Next, a precursor solution including the electrolytic solution, the high molecular compound and the mixed solvent is coated on the positive electrode 23 and the negative electrode 24, the mixed solvent is volatilized, and the electrolytic layer 26 is formed. Next, the positive electrode lead 21 is attached to the positive electrode current collector 23A and the negative electrode lead 22 is attached to the negative electrode current collector 24A. Subsequently, the positive electrode 23 and the negative electrode 24 having the electrolytic layer 26 formed thereon are laminated with the separator 25 interposed therebetween to form a lamination, the lamination is wound in a longitudinal direction, the protective tape 27 is adhered to the outermost circumference of the lamination, and the wound electrode body 20 is formed. Thereafter, for example, the wound electrode body 20 is inserted into the exterior member 30 and the outer edges of the exterior member 30 are adhered by thermal fusion. At this time, the adhesive film 31 is inserted between the positive electrode lead 21 and the negative electrode lead 22 and the exterior member 30. In this way, the secondary battery as shown in FIGS. 1 and 2 is formed.

The secondary battery may be manufactured as follows. First, as described above, the positive electrode 23 and the negative electrode 24 are manufactured, the positive electrode lead 21 and the negative electrode lead 22 are attached to the positive electrode 23 and the negative electrode 24, the positive electrode 23 and the negative electrode 24 are laminated and wound with the separator 25 interposed therebetween, the protective tape 27 is adhered to the outermost circumference of the lamination, and a wound body which is a precursor body of the wound electrode body 20 is formed. Next, the wound body is inserted into the exterior member 30, the outer edges of the wound body excluding one side is thermally fused to form a bag shape, and the wound body is contained in the exterior member 30. Subsequently, an electrolytic composition including the electrolytic solution, a monomer which is a raw material of the high molecular compound, and, if necessary, another material such as polymerization initiator or polymerization inhibitor is prepared and injected into the exterior member 30 and the opening of the exterior member 30 is thermally fused and sealed. Thereafter, if necessary, the monomer is polymerized by heating to form the high molecular compound, the gel electrolytic layer 26 is formed, and the secondary battery shown in FIGS. 1 and 2 is formed.

In this secondary battery, if charging is performed, for example, lithium ions are released from the positive electrode 23 and are stored in the negative electrode 24 via the electrolytic solution. In contrast, if discharging is performed, for example, the lithium ions are released from the negative electrode 24 and are stored in the positive electrode 23 via the electrolytic solution.

Although the embodiments of the present application are described, the present application is not limited to the embodiment and may be variously modified. For example, although the electrolytic solution is used as the electrolyte and the gel electrolyte in which the high molecular compound is hold in the electrolytic solution is used in the above-described embodiment, other electrolytes may be used. As the electrolytes, for example, a mixture of the electrolytic solution and an ion conductivity inorganic compound such as ion conductivity ceramic, ion conductive glass or ionic crystal, a mixture of the electrolytic solution and another inorganic compound or a mixture of a gel electrolyte and these organic compounds may be used.

Although the battery using lithium is described as the electrode reaction material in the above-described embodiment, the present application is applicable to the case where other alkali metal such as sodium (Na) or potassium (K), alkali earth metal such as magnesium or calcium (Ca) or other light metal such as aluminum is used.

Although the lithium ion secondary battery in which the capacity of the negative electrode appears by the capacitive component due to the storage and release of lithium or the lithium metal secondary battery in which the capacity of the negative electrode appears by the capacitive component due to the deposition and dissolution of lithium using lithium metal in the negative electrode active material are described, the present application is applicable to a secondary battery in which the capacity of the negative electrode includes the capacitive component due to the storage and release of lithium and the capacitive component due to the deposition and dissolution of lithium by decreasing the charging capacity of the negative electrode material which can store and release lithium to be lower than the charging capacity of the positive electrode.

Although the laminate secondary battery is described in the above-described embodiment, the present application is not limited to the above-described shape. That is, the present application is applicable to a cylindrical battery, a square-shaped battery or the like. The present application is not limited to the secondary battery and is applicable to other batteries such as primary battery, for example.

### EXAMPLES

### Examples 1-1 to 1-15

### Example 1-1

First, 94-wt % lithium/cobalt composite oxide (LiCoO₂) as the positive electrode active material, 3-wt % graphite as the conductive agent, 3-wt % polyvinylidene fluoride (PVdF) as the binder were uniformly mixed, N-methylpyrrolidone was added and a positive electrode mixture coating solution was obtained. Next, the obtained positive electrode mixture coating solution was uniformly coated and dried on the both surfaces of the aluminum film having a thickness of 20 μm and a positive electrode mixture layer of 20 mg/cm² per one side was formed. This was cut to have a width of 50 mm and a length of 300 mm and a positive electrode was manufactured.

Next, 97-wt % graphite as the negative electrode active material and 3-wt % PVdF as the binder were uniformly mixed, N-methylpyrrolidone was added, and a negative electrode mixture coating solution was obtained. Next, the obtained negative electrode mixture coating solution was uniformly coated and dried on the both surfaces of the aluminum film of the negative electrode current collector having a thickness of 15 μm and a negative electrode mixture layer of 10 mg/cm² per one side was formed. This was cut to have a width of 50 mm and a length of 300 mm and a negative electrode was manufactured.

The electrolytic solution was manufactured by mixing ethylene carbonate (EC)/ethylmethyl carbonate (EMC)/lithium phosphate hexafluoride/molybdenum dichloride dioxide by a ratio (mass %) of 34/51/14.9/0.1.

The positive electrode and the negative electrode were laminated with the separator formed of a porous polyethylene film having a thickness of 9 μm interposed therebetween, and were wound and inserted into a bag formed of an aluminum laminated film. The electrolytic solution was injected into the bag by 2 g, the bag was thermally fused, and a laminate battery was manufactured. The capacity of this battery was 700 mAh.

A variation in the thickness of the battery when this battery was charged for three hours at 23° C. and 700 mA by using an upper limit of 4.2 V and was maintained for four hours at 90° C. is shown in Table 1 as an expansion coefficient (%). The expansion coefficient was obtained by using the thickness of the battery before maintenance as a denominator and the thickness of the battery increased during maintenance as a numerator. A discharging capacity maintenance rate when this battery was charged for three hours at 23° C. and 700 mA by using an upper limit of 4.2 V and was repeatedly discharged 300 times at 700 mA by using a lower limit of 3.0 V is shown in Table 1.

### Examples 1-2 to 1-4

Except that the concentrations of molybdenum dichloride dioxide in the electrolytic solution was 0.02 mass %, 0.5 mass % or 0.6 mass % and the lithium phosphate hexafluoride was increased/decreased by that amount, laminate batteries were manufactured similar to Example 1-1 and the physicality of the batteries was evaluated.

### Examples 1-5 to 1-6

Except that 1-mass % fluoroethylene carbonate (FEC) or vinylene carbonate (VC) was blended in the electrolytic solution and the lithium phosphate hexafluoride was decreased by that amount, laminate batteries were manufactured similar to Example 1-1 and the physicality of the batteries was evaluated.

### Examples 1-7 to 1-15

Except that a compound including chlorine and oxygen shown in Table 1 was blended in the electrolytic solution instead of molybdenum dichloride dioxide, laminate batteries were manufactured similar to Example 1-1 and the physicality of the batteries was evaluated.

### Comparative Example 1-1

Except that molybdenum dichloride dioxide was not blended in the electrolytic solution and lithium phosphate hexafluoride was increased by that amount, laminate batteries were manufactured similar to Example 1-1 and the physicality of the battery was evaluated.

### Comparative Example 1-2

Except that titanium chloride (IV) was blended in the electrolytic solution instead of molybdenum dichloride dioxide, laminate batteries were manufactured similar to Example 1-1 and the physicality of the battery was evaluated.

### Comparative Example 1-3

Except that titanium chloride (IV) was blended in the electrolytic solution instead of molybdenum dichloride dioxide and 1-mass % fluoroethylene carbonate (FEC) was blended in the electrolytic solution, laminate batteries were manufactured similar to Example 1-1 and the physicality of the battery was evaluated.

The result of evaluating the physicality of the batteries manufactured in Examples 1-1 to 1-15 and Comparative Examples 1-1 to 1-3 is shown in Table 1.

TABLE 1
Battery in which the electrolytic solution is not immersed
in the high molecular compound

| | Compound with chlorine and oxygen | | | | | |
|---|---|---|---|---|---|---|
| | coordinated | | FEC | VC | Expansion coefficient | Maintenance |
| | | Mass % | Mass % | Mass % | of battery after four | rate after 300 |
| | | (based on | (based on | (based on | hours at 90° C. | cycles |
| | Type | solvent) | solvent) | solvent) | % | % |
| Example 1-1 | Molybdenum dichloride | 0.1 | 0 | 0 | 28 | 86.1 |
| | dioxide | | | | | |
| Example 1-2 | Molybdenum dichloride | 0.02 | 0 | 0 | 36 | 85.1 |
| | dioxide | | | | | |
| Example 1-3 | Molybdenum dichloride | 0.5 | 0 | 0 | 26 | 85.0 |
| | dioxide | | | | | |
| Example 1-4 | Molybdenum dichloride | 0.6 | 0 | 0 | 21 | 84.8 |
| | dioxide | | | | | |
| Example 1-5 | Molybdenum dichloride | 0.1 | 1 | 0 | 25 | 86.7 |
| | dioxide | | | | | |
| Example 1-6 | Molybdenum dichloride | 0.1 | 0 | 1 | 27 | 87.3 |
| | dioxide | | | | | |
| Example 1-7 | Vanadyl chloride | 0.1 | 0 | 0 | 27 | 85.9 |
| Example 1-8 | Chromyl chloride | 0.1 | 0 | 0 | 20 | 85.5 |
| Example 1-9 | Phosphoryl chloride | 0.1 | 0 | 0 | 25 | 85.6 |
| Example 1-10 | Titanium | 0.1 | 0 | 0 | 23 | 85.7 |
| | tetrachloride/2THF | | | | | |
| Example 1-11 | Zirconium | 0.1 | 0 | 0 | 26 | 85.7 |
| | tetrachloride/2THF | | | | | |
| Example 1-12 | Vanadium trichloride/3THF | 0.1 | 0 | 0 | 20 | 85.5 |
| Example 1-13 | Chrome trichloride/3THF | 0.1 | 0 | 0 | 16 | 85.8 |
| Example 1-14 | Niobium | 0.1 | 0 | 0 | 23 | 85.8 |
| | tetrachloride/2THF | | | | | |
| Example 1-15 | Aluminum trichloride/THF | 0.1 | 0 | 0 | 25 | 86.0 |
| Comparative | None | 0 | 0 | 0 | 44 | 84.9 |
| Example 1-1 | | | | | | |
| Comparative | Titanium chloride (IV) | 0.1 | 0 | 0 | 20 | 79.8 |
| Example 1-2 | | | | | | |
| Comparative | Titanium chloride (IV) | 0.1 | 1 | 0 | 16 | 84.0 |
| Example 1-3 | | | | | | |

As can be seen from Table 1, in Example 1-1 in which molybdenum dichloride dioxide of 0.1 mass % is included in the electrolytic solution, the expansion coefficient of the battery was decreased and the discharging capacity maintenance rate after 300 cycles was improved, compared with Comparative Example 1-1 in which molybdenum dichloride dioxide is not included. That is, if the compound with chlorine and oxygen coordinated is blended in the electrolytic solution, it is possible to suppress the expansion of the battery at a high temperature and improve cycle characteristics.

In Example 1-2 in which the concentration of molybdenum dichloride dioxide in the electrolytic solution is 0.02 mass %, the expansion coefficient was higher than that of Example 1-1, but the expansion coefficient can be reduced compared with Comparative Example 1-1 in which molybdenum dichloride dioxide is not blended. In contrast, in Example 1-3 in which the concentration of molybdenum dichloride dioxide in the electrolytic solution is 0.5 mass %, the expansion coefficient can be further reduced. In Examples 1-2 and 1-3, the discharging capacity maintenance rate after 300 cycles can be improved to the same degree as Example 1-1. However, in Example 1-4 in which the concentration of molybdenum dichloride dioxide in the electrolytic solution is 0.60 mass %, the expansion coefficient is reduced compared with Example 1-1, but the discharging capacity maintenance rate after 300 cycles was reduced. That is, the optimal content of the compound with chlorine and oxygen coordinated was 0.02 to 0.5 mass %.

In Examples 1-5 and 1-6 in which fluoroethylene carbonate or vinylene carbonate is blended in the electrolytic solution, the expansion coefficient of the battery can be reduced compared with Example 1-1 and thus the discharging capacity maintenance rate after 300 cycles was improved. That is, if halogenated carbonic ester or carbonate ester having a carbon-carbon multiple bond is blended in the electrolytic solution in addition to the compound with chlorine and oxygen coordinated, it is possible to suppress the expansion of the battery at a high temperature and improve cycle characteristics.

In Examples 1-7 to 1-15 in which the type of the compound with chlorine and oxygen coordinated is changed, the expansion coefficient of the battery can be reduced compared with Comparative Example 1-1 and the discharging capacity maintenance rate after 300 cycles was improved. That is, if the compound with chlorine and oxygen coordinated on the element selected from Groups 4 to 6, 12, 13 and 15 in the periodic table is blended in the electrolytic solution, it is possible to suppress the expansion of the battery at a high temperature and improve cycle characteristics.

### Examples 2-1 to 2-15

### Example 2-1

Except that the thickness of the separator was 7 μm and the separator on which polyvinylidene fluoride is coated on the both surfaces thereof by 2 μm was used, a laminate battery was manufactured similar to Example 1-1. At this time, the mass ratio of the electrolytic solution to polyvinylidene fluoride was 20:1. The expansion coefficient which is the variation in battery thickness and the discharging capacity maintenance rate when discharging is repeated 300 times are shown in Table 2.

### Examples 2-2 to 2-4

Except that the concentrations of molybdenum dichloride dioxide in the electrolytic solution was 0.02 mass %, 0.5 mass % and 0.6 mass % and the lithium phosphate hexafluoride is increased/decreased, laminate batteries were manufactured similar to Example 2-1 and the physicality of the batteries was evaluated.

### Examples 2-5 to 2-6

Except that 1-mass % fluoroethylene carbonate (FEC) or vinylene carbonate (VC) was blended in the electrolytic solution and the lithium phosphate hexafluoride is increased/decreased, laminate batteries were manufactured similar to Example 2-1 and the physicality of the batteries was evaluated.

### Examples 2-7 to 2-15

Except that a compound including chlorine and oxygen shown in Table 2 was blended in the electrolytic solution instead of molybdenum dichloride dioxide, laminate batteries were manufactured similar to Example 2-1 and the physicality of the batteries was evaluated.

### Comparative Example 2-1

Except that molybdenum dichloride dioxide is not blended in the electrolytic solution and lithium phosphate hexafluoride is increased/decreased, a laminate battery was manufactured similar to Example 2-1 and the physicality of the battery was evaluated.

The result of evaluating the physicality of the batteries manufactured in Examples 2-1 to 2-15 and Comparative Example 2-1 is shown in Table 2.

TABLE 2
High molecular compound: polyvinylidene fluoride

| | Compound with chlorine and | | | | Expansion | |
|---|---|---|---|---|---|---|
| | oxygen coordinated | | FEC | VC | coefficient of | Maintenance |
| | | Mass % | Mass % | Mass % | battery after four | rate after 300 |
| | | (based on | (based on | (based on | hours at 90° C. | cycles |
| | Type | solvent) | solvent) | solvent) | % | % |
| Example 2-1 | Molybdenum dichloride | 0.1 | 0 | 0 | 19 | 84.8 |
| | dioxide | | | | | |
| Example 2-2 | Molybdenum dichloride | 0.02 | 0 | 0 | 24 | 83.8 |
| | dioxide | | | | | |
| Example 2-3 | Molybdenum dichloride | 0.5 | 0 | 0 | 17 | 83.7 |
| | dioxide | | | | | |
| Example 2-4 | Molybdenum dichloride | 0.6 | 0 | 0 | 14 | 83.5 |
| | dioxide | | | | | |
| Example 2-5 | Molybdenum dichloride | 0.1 | 1 | 0 | 17 | 85.4 |
| | dioxide | | | | | |
| Example 2-6 | Molybdenum dichloride | 0.1 | 0 | 1 | 18 | 86.0 |
| | dioxide | | | | | |
| Example 2-7 | Vanadyl chloride | 0.1 | 0 | 0 | 18 | 84.6 |
| Example 2-8 | Chromyl chloride | 0.1 | 0 | 0 | 14 | 84.2 |
| Example 2-9 | Phosphoryl chloride | 0.1 | 0 | 0 | 16 | 84.3 |
| Example 2-10 | Titanium | 0.1 | 0 | 0 | 15 | 84.4 |
| | tetrachloride/2THF | | | | | |
| Example 2-11 | Zirconium | 0.1 | 0 | 0 | 17 | 84.4 |
| | tetrachloride/2THF | | | | | |
| Example 2-12 | Vanadium | 0.1 | 0 | 0 | 13 | 84.2 |
| | trichloride/3THF | | | | | |
| Example 2-13 | Chrome trichloride/3THF | 0.1 | 0 | 0 | 10 | 84.5 |
| Example 2-14 | Niobium | 0.1 | 0 | 0 | 15 | 84.5 |
| | tetrachloride/2THF | | | | | |
| Example 2-15 | Aluminum | 0.1 | 0 | 0 | 17 | 84.7 |
| | trichloride/THF | | | | | |
| Comparative | None | 0 | 0 | 0 | 30 | 83.6 |
| Example 2-1 | | | | | | |

As can be seen from Table 2, in Example 2-1 in which molybdenum dichloride dioxide is included in the electrolytic solution, the expansion coefficient of the battery was decreased and the discharging capacity maintenance rate after 300 cycles was improved, compared with Comparative Example 2-1 in which molybdenum dichloride dioxide is not included. The expansion suppressing effect was further improved compared with Example 1-1 in which polyvinylidene fluoride is not included. That is, if polyvinylidene fluoride is further included in the electrolytic solution as the high molecular compound in addition to the compound in which chlorine and oxygen are blended, it is possible to further suppress the expansion of the battery at a high temperature.

In Example 2-2 in which the concentration of molybdenum dichloride dioxide in the electrolytic solution is 0.02 mass %, the expansion coefficient was higher than that of Example 2-1, but the expansion coefficient can be reduced compared with Comparative Example 2-1 in which molybdenum dichloride dioxide is not blended. In contrast, in Example 2-3 in which the concentration of molybdenum dichloride dioxide in the electrolytic solution is 0.5 mass %, the expansion coefficient can be further reduced. In Examples 2-2 and 2-3, the discharging capacity maintenance rate after 300 cycles can be improved to the same degree as Example 1-1. However, in Example 2-4 in which the concentration of molybdenum dichloride dioxide in the electrolytic solution is 0.6 mass %, the expansion coefficient was reduced compared with Example 2-1, but the discharging capacity maintenance rate after 300 cycles was reduced.

In Examples 2-5 and 2-6 in which fluoroethylene carbonate or vinylene carbonate is blended in the electrolytic solution, the expansion coefficient of the battery can be reduced compared with Example 1-1 and thus the discharging capacity maintenance rate after 300 cycles was improved. That is, if halogenated carbonic ester or carbonate ester having a carbon-carbon multiple bond is blended in the electrolytic solution in addition to the compound with chlorine and oxygen coordinated, it is possible to suppress the expansion of the battery at a high temperature and improve cycle characteristics.

In Examples 2-7 to 2-15 in which the type of the compound with chlorine and oxygen coordinated is changed, the expansion coefficient of the battery can be reduced to the same degree as Example 1-1 and the discharging capacity maintenance rate after 300 cycles was retained. That is, even when the electrolytic solution is immersed in the high molecular compound, similar to the case where the electrolytic solution is not immersed, if the compound with chlorine and oxygen coordinated on the element selected from Groups 4 to 6, 12, 13 and 15 in the periodic table is blended in the electrolytic solution, it is possible to suppress the expansion of the battery at a high temperature and improve cycle characteristics.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous secondary battery comprising:
a positive electrode;
a negative electrode; and
a nonaqueous electrolytic solution,
wherein the nonaqueous electrolytic solution includes a compound with oxygen and halogen coordinated on an element selected from Groups 4 to 15 in the periodic table.

2. The nonaqueous secondary battery according to claim 1, wherein the concentration of the compound with oxygen and halogen coordinated on the element selected from Groups 4 to 15 in the periodic table in the nonaqueous electrolytic solution is 0.02 to 0.5 mass %.

3. The nonaqueous secondary battery according to claim 1, wherein the halogen includes chlorine.

4. The nonaqueous secondary battery according to claim 1, wherein the element includes at least one of molybdenum, vanadium, chrome, phosphorous, titanium, zirconium, niobium and aluminum.

5. The nonaqueous secondary battery according to claim 1, wherein the oxygen configures ether having a structure expressed by Formula (1) or (2) 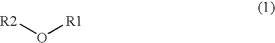
[in Formula (1), R1 and R2 each independently denotes an alkyl group having a carbon number of 1 to 4] 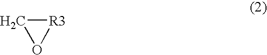
[in Formula (2), R3 denotes an alkylene group having a carbon number of 1 to 5].

6. The nonaqueous secondary battery according to claim 5, wherein the ether is tetrahydrofuran.

7. The nonaqueous secondary battery according to claim 1, wherein the nonaqueous electrolytic solution further includes halogenated carbonic ester.

8. The nonaqueous secondary battery according to claim 7, wherein the halogenated carbonic ester is fluoroethylene carbonate.

9. The nonaqueous secondary battery according to claim 1, wherein the nonaqueous electrolytic solution includes carbonate ester having a carbon-carbon multiple bond.

10. The nonaqueous secondary battery according to claim 9, wherein the carbonate ester is vinylene carbonate.

11. The nonaqueous secondary battery according to claim 1, further comprising a high molecular compound which swells the electrolytic solution.

12. The nonaqueous secondary battery according to claim 11, wherein the high molecular compound is polyvinylidene fluoride.

13. The nonaqueous secondary battery according to claim 1, wherein the electrode body and the nonaqueous electrolytic solution are contained in an exterior member formed of a laminate film.

14. A nonaqueous electrolyte composition comprising: a compound with oxygen and halogen coordinated on an element selected from Groups 4 to 15 in the periodic table.

15. The nonaqueous electrolyte composition according to claim 14, wherein the concentration of the compound with oxygen and halogen coordinated on the element selected from Groups 4 to 15 in the periodic table is 0.02 to 0.5 mass %.

16. The nonaqueous electrolyte composition according to claim 10, wherein the halogen includes chlorine.

17. The nonaqueous electrolyte composition according to claim 10, wherein the element includes at least one of molybdenum, vanadium, chrome, phosphorous, titanium, zirconium, niobium and aluminum.

18. The nonaqueous electrolyte composition according to claim 14, wherein the oxygen configures ether having a structure expressed by Formula (1) or (2) 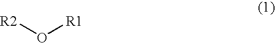
[in Formula (1), R1 and R2 each independently denotes an alkyl group having a carbon number of 1 to 4] 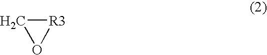
[in Formula (2), R3 denotes an alkylene group having a carbon number of 1 to 5].

19. The nonaqueous electrolyte composition according to claim 18, wherein the ether is tetrahydrofuran.

20. The nonaqueous electrolyte composition according to claim 14, further comprising halogenated carbonic ester.

21. The nonaqueous electrolyte composition according to claim 20, wherein the halogenated carbonic ester is fluoroethylene carbonate.

22. The nonaqueous electrolyte composition according to claim 14, further comprising carbonate ester having a carbon-carbon multiple bond.

23. The nonaqueous electrolyte composition according to claim 22, wherein the carbonate ester is vinylene carbonate.
